(19) United States
(12) Patent Application Publication
(10) Pub. No.: US 2018/0297331 A1
(43) Pub. Date: Oct. 18, 2018

(54) LAMINATE STRUCTURES AND AUTOMOTIVE GLAZINGS COMPRISING LIGHT GUIDE PLATES

(71) Applicant: CORNING INCORPORATED, CORNING, NY (US)

(72) Inventor: Kevin Thomas Gahagan, Painted Post, NY (US)

(21) Appl. No.: 15/578,388

(22) PCT Filed: Jun. 1, 2016
(86) PCT No.: PCT/US2016/035137

§ 371 Date: Nov. 30, 2017

Related U.S. Application Data
(60) Provisional application No. 62/169,910, filed on Jun. 2, 2015.

(51) Int. Cl. B32B 17/10; C03C 3/085; C03C 3/087; C03C 3/083; C03C 3/078; B60J 1/00; F21V 8/00

(52) U.S. Cl. CPC B32B 17/10036; B60J 1/02; C03C 3/087; C03C 3/083; C03C 3/078; B60J 1/001; G02B 6/005; G02B 6/0065; B32B 17/10091; B32B 17/101; B32B 17/10119; B32B 17/10137; B32B 17/10541; B32B 17/10761; B32B 17/1077; B32B 17/10788; B32B 17/10486; B32B 17/10045; C03C 3/085

(57) ABSTRACT

Disclosed herein are laminate structures comprising a light guide plate including a first glass sheet, wherein the first glass sheet comprises from about 50 mol % to about 90 mol % SiO₂, from about 0 mol % to about 15 mol % Al₂O₃, and about 0 mol % to about 19 mol % RₓO, wherein x is 1 and R is chosen from Zn, Mg, Ca, Sr, or Ba, or wherein x is 2 and R is chosen from Li, Na, K, Rb, or Cs, and wherein the concentration of Fe is less than about 50 ppm

### CROSS-REFERENCE TO RELATED APPLICATIONS

This application claims the benefit of priority under 35 U.S.C. § 119 of U.S. Provisional Application Ser. No. 62/169910 filed on Jun. 2, 2015, the content of which is relied upon and incorporated herein by reference in its entirety.

### FIELD OF THE DISCLOSURE

The disclosure relates to laminate structures and, more particularly, to automotive glazings comprising light guide plates.

### BACKGROUND

The automotive industry has recently begun incorporating glass as external and/or internal surfaces of vehicles to increase the aesthetics of the vehicle and/or to increase the visibility of the exterior surroundings for the passengers. For example, glass laminates may be used as functional or decorative components, e.g., windows, sunroofs, mirrors, and exterior or interior paneling. Glass laminates are also attractive as automotive glazings because breakage safety and/or impact resistance can be improved by incorporating one or more thermally tempered and/or chemically strengthened glass sheets. Additionally, using relatively thin glass sheets can provide one or more of the advantages discussed herein without the drawback of adding excessive weight to the vehicle. As such, automotive glazings comprising at least one glass sheet can also avoid or reduce negative impacts on fuel efficiency, emissions, and/or the center of gravity of the vehicle.

Increasing demand for automotive glazings with additional functionality, e.g., the ability to display an image and/or touch screen capability, has driven the search for new substrates capable of both reflecting and transmitting light. For example, it may be desirable to provide a transparent or substantially transparent automotive glazing (e.g., a windshield, side window, rear view window, sunroof, or moonroof) that can both provide a clear view of the exterior surroundings, while also having the ability to display a desired image or otherwise interact with the user.

Unfortunately, transparent displays may still have various drawbacks, such as poor light transmission and/or reflection, which can greatly limit the contrast ratio of the display. Commercially transparent displays may, for example, offer only about 15% transmission, with even lower performance in reflection mode. Alternative methods for displaying images on transparent glazings include heads-up displays (HUDs), which can employ one or more films to reflect an image onto the glazing, e.g., windshield. However, HUDs often suffer from an effect referred to as “ghosting” in which the user sees two separate imagesone reflection from an interior glass sheet in the laminate or glazing and one reflection from an exterior glass sheet in the laminate or glazing.

Accordingly, it would be advantageous to provide an automotive glazing that can both transmit and reflect light and, in some cases, serve as a light source itself. It would also be advantageous to provide an automotive glazing able to display a desired image with little or no distortion. These and other aspects of the disclosure are discussed in further detail herein.

### SUMMARY

The disclosure relates, in various embodiments, to laminate structures comprising a light guide plate including a first glass sheet, wherein the first glass sheet comprises from about 50 mol % to about 90 mol % SiO₂, from about 0 mol % to about 15 mol % Al₂O₃, and about 0 mol % to about 19 mol % RₓO, wherein x is 1 and R is chosen from Zn, Mg, Ca, Sr, or Ba, or wherein x is 2 and R is chosen from Li, Na, K, Rb, or Cs, and wherein the concentration of Fe is less than about 50 ppm. According to various embodiments, the first glass sheet may further comprise from about 0 mol % to about 10 mol % B₂O₃. In additional embodiments, the first glass sheet can comprise less than about 1 ppm of each of Co, Ni, and Cr.

The light guide plate can, in some embodiments, reflect and transmit light efficiently, such that the light guide plate produces less than or equal to 2 dB/500 mm of light attenuation and/or less than or equal to about 1 dB/500 mm of light absorption in a wavelength range of about 400 nm to about 700 nm. The light guide may scatter light within an angle less than about 12.8 degrees full width half minimum (FWHM) in transmission mode and/or diffuse light within an angle less than about 6.4 degrees in reflection mode. According to various non-limiting embodiments, the light guide plate can have a haze value of less than about 6%. The light guide plate can furthermore comprise at least one surface having an RMS roughness (R_{q}) ranging from about 5 nm to about 75 nm.

In certain embodiments, the laminate structures can comprise at least one of a second glass sheet and/or a polymer interlayer. Suitable interlayers can include, for example, polyvinyl butyral, ethylene-vinyl acetate, thermoplastic polyurethanes, ionomers, and combinations thereof. According to additional embodiments, the laminate structures can comprise a core including a first glass sheet and an exterior cladding comprising a second glass sheet. The cladding can be on either or both major side surfaces of the interior core. The second glass sheet can comprise, in some embodiments, a photochromic glass sheet. In non-limiting embodiments, the second glass sheet can comprise soda lime, aluminosilicate, alkali-aluminosilicate, borosilicate, alkali-borosilicate, aluminoborosilicate, or alkali-aluminoborosilicate glass, which may be chemically strengthened and/or thermally tempered and/or annealed. The first and/or second glass sheets can furthermore comprise a thickness ranging from about 0.3 mm to about 8 mm.

Laminate structures as described herein can be used as automotive glazings comprising all or a portion of a windshield, rear window, side window, sunroof, moonroof, exterior panel, or interior panel of a vehicle. At least one light source, such as an LED, CCFL, or OLED can be optically coupled to at least one edge of the light guide of the automotive glazing. In non-limiting embodiments, the laminate structure can further comprise at least one additional component chosen from electrochromic layers, polymer layers, reflective layers, polarizing layers, filtering layers, sensors, indicators, active devices, and combinations thereof.

Additional features and advantages will be set forth in the detailed description which follows, and in part will be readily apparent to those skilled in the art from that description or recognized by practicing the methods described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding, and are incorporated into and constitute a part of this specification. The drawings illustrate various non-limiting embodiments and together with the description serve to explain the principles and operations of the disclosure.

### BRIEF DESCRIPTION OF THE DRAWINGS

Various features, aspects and advantages of the present disclosure are better understood when the following detailed description is read with reference to the accompanying drawings, wherein like structures are indicated with like reference numerals when possible, and in which:

FIG. 1 illustrates an exemplary vehicle having various components which may be comprise automotive glazings according to certain embodiments of the disclosure;

FIGS. 2A-B illustrate exemplary windshields comprising various light guide plate orientations according to embodiments of the disclosure;

FIGS. 3A-B illustrate exemplary side windows comprising various light guide plate orientations according to embodiments of the disclosure; and

FIGS. 4A-B illustrates exemplary laminate structures according to additional embodiments of the disclosure.

### DETAILED DESCRIPTION

Disclosed herein are laminate structures comprising a light guide plate including a first glass sheet, wherein the first glass sheet comprises from about 50 mol % to about 90 mol % SiO₂, from about 0 mol % to about 15 mol % Al₂O₃, and about 0 mol % to about 19 mol % RₓO, wherein x is 1 and R is chosen from Zn, Mg, Ca, Sr, or Ba, or wherein x is 2 and R is chosen from Li, Na, K, Rb, or Cs, and wherein the concentration of Fe is less than about 50 ppm. Also disclosed herein are laminate structures comprising a first glass sheet, a polymer interlayer, and a second glass sheet, wherein the first glass sheet is a glass light guide comprising from about 50 mol % to about 90 mol % SiO₂, from about 0 mol % to about 15 mol % Al₂O₃, and about 0 mol % to about 19 mol % RₓO, wherein x is 1 and R is chosen from Zn, Mg, Ca, Sr, or Ba, or wherein x is 2 and R is chosen from Li, Na, K, Rb, or Cs, and wherein the concentration of Fe is less than about 50 ppm. Further disclosed herein are laminate structures comprising a first outer clad glass sheet and an interior core glass sheet; wherein the interior core glass sheet is a light guide plate having from about 50 mol % to about 90 mol % SiO₂, from about 0 mol % to about 15 mol % Al₂O₃, and about 0 mol % to about 19 mol % RₓO, wherein x is 1 and R is chosen from Zn, Mg, Ca, Sr, or Ba, or wherein x is 2 and R is chosen from Li, Na, K, Rb, or Cs, and wherein the concentration of Fe is less than about 50 ppm.

As used herein, the terms “laminate structure,” “laminate,” and variations thereof are intended to denote a multi-layer substrate, such as an automotive glazing, comprising at least one glass sheet. Laminates can, for example, comprise a first glass sheet, a second glass sheet, and a polymer interlayer. Laminates or glazings can also include glass substrates comprising a core and cladding, such as a core comprising a first glass sheet or composition and a cladding comprising a second glass sheet or composition, which can be present on either or both major surfaces of the core glass sheet.

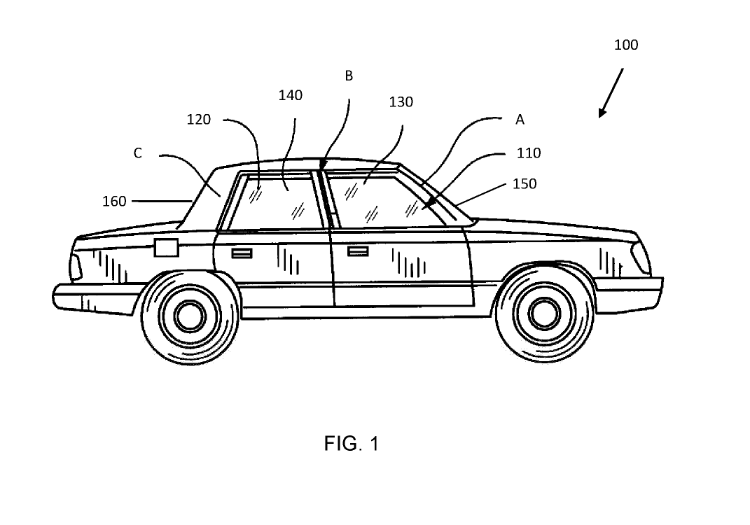

Automotive glazings may be used in a wide range of applications in accordance with various aspects of the disclosure. For example, automotive glazings may be used in various functional and/or decorative applications such as exterior and interior surfaces of vehicles including, but not limited to, cars, trucks, buses, and boats. FIG. 1 illustrates an exemplary vehicle 100, which includes front and rear assemblies 110 and 120, having front and rear side windows 130 and 140. The vehicle 100 also comprises a forward pillar A, conventionally referred to as an A-pillar, a rear pillar C, conventionally referred to as a C-pillar, and a center pillar B, located between the front and rear side windows 130 and 140 and conventionally referred to as a B-pillar. The vehicle 100 can further comprises a windshield 150, rear window 160, and a sunroof or moonroof (not illustrated). According to various non-limiting embodiments, the automotive glazings disclosed herein can comprise all or a portion of the illustrated vehicle components including, but not limited to, the front window (windshield), rear window, side windows, sunroof, moonroof, and/or exterior paneling, including, for instance, the A, B, and/or C panels. In additional embodiments, the automotive glazings can be used on interior panels inside the vehicle 100 (not illustrated), such as the dashboard, console, interior side paneling, and/or seats, e.g., headrests. Of course, automotive glazings according to the instant disclosure can also be applied to other exterior or interior portions of the vehicle.

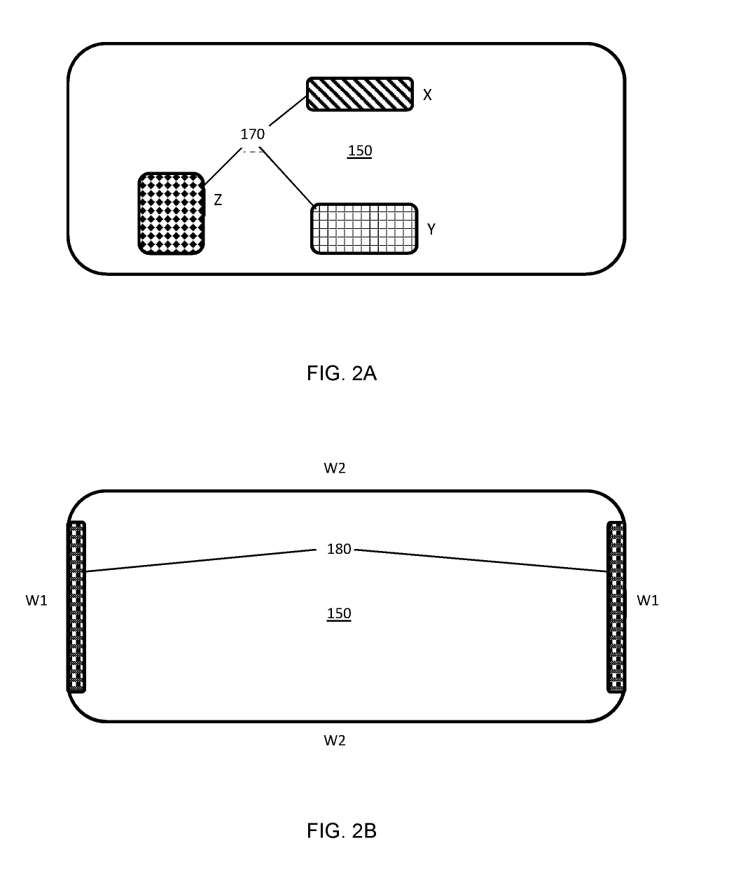

For example, as depicted in FIG. 2A, an exemplary automotive glazing can comprise a windshield 150, at least a portion of which can comprise at least one light guide plate 170. The light guide plate can be positioned in any location on the windshield 150 as desired. For example, in position X, the light guide plate can serve a rear view mirror function, according to various embodiments. In positions Y and Z, the light guide plate can serve, for example, as a heads-up display (HUD). Of course the depicted locations and sizes of the light guide plates 170 are exemplary only and not intended to be limiting on the appended claims. FIG. 2B depicts an alternative embodiment of a windshield, in which the entire glazing comprises a light guide plate (not labeled). As illustrated, at least one light source 180 (e.g., LED, CCFL, OLED) can be coupled to at least one edge (W1, W2) of the light guide plate. While FIG. 2B depicts light sources arranged in a column along two opposing side edges W1 of the windshield, it is to be understood that any light source arrangement, including type, number, and location, is envisioned as falling within the scope of the disclosure. For instance, only one edge W1 of the light guide plate may be coupled to one or more light sources, or one or both edges W2 can be coupled to one or more light sources.

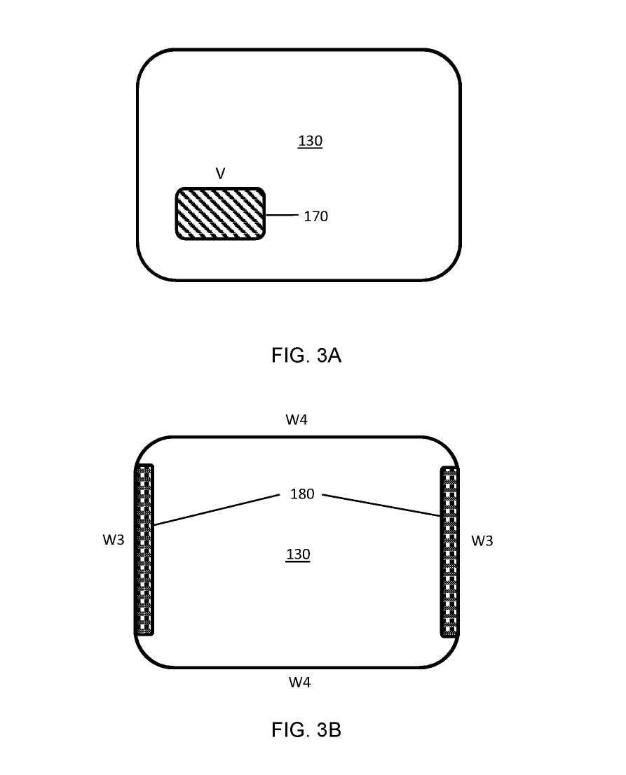

Similarly, as depicted in FIG. 3A, which illustrates an exemplary side window 130, at least a portion of the automotive glazing can comprise at least one light guide plate 170. The light guide plate can be positioned in any location on the side window 130 as desired. For example, in position V, the light guide plate can serve a side view mirror function, according to various embodiments. Of course the depicted location and size of the light guide plate 170 are exemplary only and not intended to be limiting on the appended claims. FIG. 3B depicts an alternative embodiment of a side window, in which the entire glazing comprises a light guide plate (not labeled). As illustrated, at least one light source 180 can be coupled to at least one edge (W3, W4) of the light guide plate. While FIG. 3B depicts light sources arranged in a column along two opposing side edges W3 of the side window 130, it is to be understood that any light source arrangement, including type, number, and location, is envisioned as falling within the scope of the disclosure. For instance, only one edge W3 of the light guide plate may be coupled to one or more light sources, or one or both edges W4 can be coupled to one or more light sources.

According to various embodiments (see, e.g., FIGS. 1-3), the laminate structure comprising at least one light guide plate 170 can be used for numerous functions, e.g., as automotive glazings. For instance, the laminate structure can be configured as a white or black “dead” screen onto which an image may be projected from a separate device. In other embodiments, the laminate structure can be part of a display unit, such as an LCD, on which any number of images may be displayed, such as static or moving images, e.g., images from a separate camera or any other device capable of generating an image. The laminate structures and automotive glazings disclosed herein can be used to display high resolution images, such as up to about 300 pixels per inch (ppi). In some non-limiting embodiments, the automotive glazing can display images that would be seen, e.g., from conventional rear view (see, e.g., FIGS. 2A-B) or side view mirrors (see, e.g., FIGS. 3A-B). In other embodiments, the automotive glazing can display indicators, signals, or other images, such as vehicle speed, GPS navigation directions, fuel levels, and the like on glazings having a sheet facing the environment (see, e.g., FIGS. 2-3) or on interior glazings (e.g., paneling, consoles, dashboards, interior displays, and the like). According to further embodiments, the display area of the automotive glazing can be further equipped with one or more features enabling the user to touch or otherwise interact with the display, for example, a touch pad or sensor on any exterior structure, e.g., windshield, rear and side windows, sunroof, moonroof, and/or exterior paneling (e.g., A, B, and/or C panels) as well as interior structures such as, but not limited to dashboards, consoles, interior side paneling, and/or seats, e.g., headrests.

In still further embodiments, the laminate structure can include at least one light source, such as an LED light source coupled to one or more edges, and all or part of the glazing can be used as an integrated lighting device, e.g., a luminaire, which can provide ambient or directional lighting for the interior or exterior surroundings of the vehicle. Moreover, one or more transparent exterior glazings (e.g., the windshield, rear window, side window, moonroof, or sunroof) comprising a light guide and light source can be configured as a backlight unit for an integrated transparent LCD display. The light sources can also be configured to serve other non-display functions, such as a means for defrosting a window, e.g., a windshield, rear window, or side windows, using heat generated by the light source. Again, it should be noted that while may embodiments are described with respect to glazings having an exterior sheet (e.g., windshield, rear and side windows, sunroof, moonroof, and/or exterior paneling (e.g., A, B, and/or C panels)), the claims appended herewith should not be so limited as these embodiments can be applicable to interior structures such as, but not limited to dashboards, consoles, interior side paneling, and/or seats, e.g., headrests.

The laminate structure or automotive glazing can also be used, for example, to display images and/or generate light and/or provide interactive controls via one or both surfaces. For instance, an exterior surface of the glazing can be configured to display a touch pad image which can be used, e.g., for locking and unlocking a door, whereas the interior can display an image, such as a side view mirror image or footage. One or both sides of the glazing can also be configured to provide a camera view and/or to illuminate upon command. For instance, upon approach, the interior of the vehicle can be illuminated and/or otherwise made visible for safety purposes.

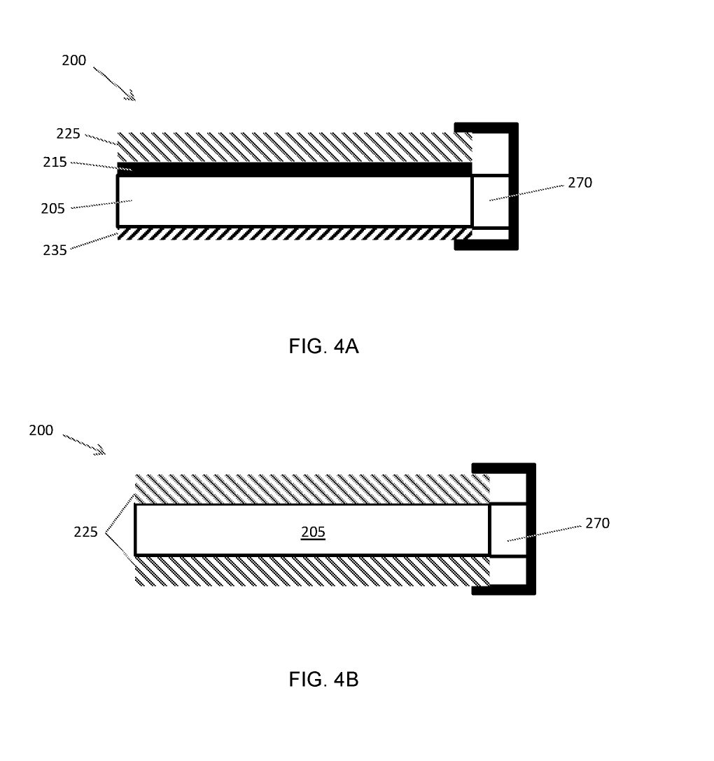

FIG. 4A illustrates a cross-sectional view of a non-limiting laminate structure 200 equipped with a light source 270. The laminate structure can comprise, in some embodiments, a first glass sheet (light guide plate) 205, an interlayer 215, a second glass sheet 225, and an optional additional layer or component 235. While the optional component 235 is illustrated as contacting the first glass sheet 205, it is to be understood that the additional layer or component can be incorporated anywhere in the glazing, such as between the first and second glass sheets and/or interlayer, or on top of the second glass sheet, and so on.

The first and second glass sheets 205, 225 can be formed using any method known in the art, for example, fusion down draw, slot draw, and float processes, to name a few. The laminate structure of FIG. 4A can be manufactured using any known method in the art, for example, thermal or cold forming. For example, the first and/or second glass sheets may be chosen so as to be thin enough to enable it to conform to a non-planar shape, yet strong enough not to break when so formed. The shaping of flat glass sheets to form a non-flat (or non-planar) shape, without raising the temperature of the glass to its softening point is known as “cold-forming” or “cold-bending.” When cold-forming glass, the force required to bend the glass out of plane will be converted to stress in the glass. The glass should possess sufficient strength to absorb this additional stress in addition to the strength necessary to provide whatever function the application requires. The stiffness of a sheet of glass can be proportional to the cube of its thickness, thus a much greater force may be needed to bend a thicker sheet of glass than a thinner sheet of glass to the same radius. In the case of cold-forming, thin glass has the advantage of generating a much lower internal stress when bent to a particular shape or radius.

In some embodiments, the first and/or second glass sheet (depending upon its use and the respective glazing or laminate's use) can have a thickness ranging from about 0.3 mm to about 8 mm, such as from about 0.5 mm to about 7 mm, from about 0.7 mm to about 6 mm, from about 1 mm to about 5 mm, from about 1 mm to about 4 mm, from about 1.5 mm to about 3 mm, or from about 2 mm to about 2.5 mm, including all ranges and subranges therebetween. The thickness of the first and second glass sheets can, in some embodiments, be identical or different.

The first glass sheet 205 and second glass sheet 225 can, in some embodiments, be attached by an interlayer 215, such as a polymer interlayer. Suitable interlayers or adhesives can include, for example, ethylene vinyl acetate (EVA), thermoplastic polyurethanes (TPU), polyvinyl butyral (PVB), and ionomers, such as SentryGlas® ionomer from DuPont, or any other suitable interlayer material. In certain embodiments, the interlayer may be chosen from EVA and PVB. According to non-limiting embodiments, the interlayer 215 can be selected from those having a Young's modulus greater than or equal to 15 MPa, such as greater than or equal to about 30 MPa, about 50 MPa, about 100 MPa, about 150 MPa, about 200 MPa, about 250 MPa, about 300 MPa, about 350 MPa, or about 400 MPa, including all ranges and subranges therebetween. In certain embodiments, the interlayer 215 may have a thickness ranging from about 0.1 mm to about 2 mm, such as from about 0.3 mm to about 1.5 mm, from about 0.5 mm to about 1.2 mm, from about 0.75 to about 1.1 mm, or from about 0.9 to about 1 mm, including all ranges and subranges therebetween. According to certain embodiments, an optically clear interlayer can be provided that is substantially transparent, although opaque and possibly colored interlayers may be provided in further examples.

As shown in FIG. 4B, the laminate structure 200 can comprise first and second glass sheets 205, 225 not attached by an interlayer. For example, the laminate structure can have a core comprising a first glass sheet 205 and a cladding on either or sides of the core comprising one or more second glass sheets 225 (both sides illustrated in FIG. 4B). The laminate structure can, for example, comprise an interior core glass sheet, a first exterior clad glass sheet, and an optional second exterior clad glass sheet, where the core and clad glass sheets can be different, and wherein the first and second clad sheets can be identical or different. Additionally, although not illustrated, the laminate structure 200 of FIG. 4B can be equipped with one or more optional layers or devices on any surface of the glazing. Methods for producing clad glass substrates can include, for example, a fusion down draw method employing two or more forming bodies or isopipes. Such methods are disclosed, for example, in U.S. Pat. Nos. 4,214,886 and 7,201,965 and U.S. Patent Publication No. 2011/0318555, all of which are incorporated herein by reference in their entireties.

The laminate structure 200 and/or first glass sheet 205 and/or second glass sheet 225 as depicted in FIGS. 4A-B can comprise a first surface and an opposing second surface. The surfaces may, in certain embodiments, be planar or substantially planar, e.g., substantially flat and/or level. The laminate structure 200, first glass sheet 205, and/or second glass sheet 225 can also, in some embodiments, be curved about one radius of curvature, or multiple radii of curvature, e.g., a three-dimensional glass substrate, such as a convex or concave substrate. The laminate structure 200, first glass sheet 205, and/or second glass sheet 225 may further comprise at least one edge, for instance, at least two edges, at least three edges, or at least four edges. By way of a non-limiting example, the laminate structure 200, first glass sheet 205, and/or second glass sheet 225 may comprise a rectangular or square glass sheet having four edges, although other shapes and configurations are envisioned and are intended to fall within the scope of the disclosure. According to various embodiments, any one or both of the glass sheets 205, 225 can be used as a light guide.

According to various embodiments, the first and/or second glass sheet 205, 225 can comprise from about 50 mol % to about 90 mol % SiO₂, from about 0 mol % to about 15 mol % Al₂O₃, and about 0 mol % to about 19 mol % RₓO, wherein x is 1 and R is chosen from Zn, Mg, Ca, Sr, or Ba, or wherein x is 2 and R is chosen from Li, Na, K, Rb, or Cs, and wherein the concentration of Fe is less than about 50 ppm.

Embodiments of the present subject matter also relate to a light guide plate where the glass further comprises RₓO where R is Li, Na, K, Rb, Cs, and x is 2, or R is Mg, Ca, Sr or Ba, and x is 1, and the mol % of RₓO is approximately equal to the mol % of Al₂O₃. Additional embodiments relate to a light guide plate where at least one edge is a light injection edge that scatters light within an angle less than 12.8 degrees full width half maximum (FWHM) in transmission. Some embodiments provide a light guide plate, comprising a glass sheet with a front face having a width and a height, a back face opposite the front face, and a thickness between the front face and back face, forming four edges around the front and back faces, wherein the glass sheet comprises between about 50 mol % to about 90 mol % SiO₂, between about 0 mol % to about 20 mol % Al₂O3, 0 mol % to about 20 mol % B₂O₃, and about 0 mol % to about 19 mol % RₓO, wherein R is any one or more of Li, Na, K, Rb, Cs and x is 2, or Zn, Mg, Ca, Sr or Ba and x is 1, and wherein the glass produces less than or equal to 1 dB/500 mm absorption. In some embodiments, RₓO—Al₂O3>0; 0<RₓO—Al₂O3<15; x=2 and R₂O—Al₂O3<15; or R₂O—Al₂O3<2. In other embodiments, x=2 and R₂O—Al₂O₃—MgO>−10; 0<(RₓO—Al₂O₃)<12, −1<(R₂O—Al₂O₃)<11, and −10<(R₂O—Al₂O₃—MgO)<11; or −1<(R₂O—Al₂O₃)<2 and −6<(R₂O—Al₂O₃—MgO)<1.

Further embodiments provide a light guide plate, comprising a glass sheet with a front face having a width and a height, a back face opposite the front face, and a thickness between the front face and back face, forming four edges around the front and back faces, wherein the glass sheet comprises between about 60 mol % to about 80 mol % SiO₂, between about 0.1 mol % to about 15 mol % Al₂O3, 0 mol % to about 10 mol % B₂O₃, and about 0.1 mol % to about 15 mol % R2O and about 0.1 mol % to about 12 mol % RO, wherein R is any one or more of Li, Na, K, Rb, Cs and x is 2, or Zn, Mg, Ca, Sr or Ba and x is 1, and wherein the glass produces less than or equal to 1 dB/500 mm absorption.

Additional embodiments include a display device comprising a light guide plate comprising a glass sheet having a Young's modulus of between about 62 GPa to about 78 GPa, wherein the glass sheet comprises between about 0 mol % to about 15 mol % Al₂O₃ and about 2 mol % to about 19 mol % RₓO, wherein R is any one or more of Li, Na, K, Rb, Cs and x is 2, or Mg, Ca, Sr or Ba and x is 1, and wherein the transmittance of the glass sheet at 450 nm with at least 500 mm in length is greater than or equal to 85%, the transmittance of the glass sheet at 550 nm with at least 500 mm in length is greater than or equal to 90%, or the transmittance of the glass sheet at 630 nm with at least 500 mm in length is greater than or equal to 85%.

Further embodiments include a glass sheet having between about 0 mol % to about 15 mol % Al₂O₃, and about 2 mol % to about 19 mol % RₓO, wherein R is any one or more of Li, Na, K, Rb, Cs and x is 2, or Zn, Mg, Ca, Sr or Ba and x is 1, wherein RₓO—Al₂O₃ is <15, and wherein the transmittance of the glass sheet at 450 nm with at least 500 mm in length is greater than or equal to 85%, the transmittance of the glass sheet at 550 nm with at least 500 mm in length is greater than or equal to 90%, or the transmittance of the glass sheet at 630 nm with at least 500 mm in length is greater than or equal to 85%.

In some embodiments, the Fe concentration of the glass sheet is <about 50 ppm; the Fe of the glass sheet is <about 20 ppm; or the concentration of Fe is <10 ppm. In other embodiments, x=2 and RₓO—Al₂O3<12; RₓO—Al₂O3>0; R₂O—Al₂O3<2; x=2 and wherein R₂O—Al₂O₃—MgO>−10; 0<(RₓO—Al₂O₃)<12, −1<(R₂O—Al₂O₃)<11, and −10<(R₂O—Al₂O₃—MgO)<11; or −1<(R₂O—Al₂O₃)<2 and −6<(R₂O—Al₂O₃—MgO)<1. Additional embodiments include a light guide plate comprising a glass sheet having between about 50 mol % to about 90 mol % SiO₂, between about 0 mol % to about 15 mol % Al₂O₃, between about 0 mol % to about 10 mol % B₂O₃, and about 2 mol % to about 19 mol % RₓO, wherein RₓO is (Li₂O+Na₂O+K₂O+Rb₂O+Cs₂O+MgO+CaO+SrO+BaO), and wherein Al₂O₃+MgO is less than or equal to RₓO. Some embodiments include a glass article comprising a glass sheet having between about 50 mol % to about 90 mol % SiO₂, between about 0 mol % to about 15 mol % Al₂O₃, between about 0 mol % to about 10 mol % B₂O₃, and about 2 mol % to about 19 mol % RₓO, wherein R is any one or more of Li, Na, K, Rb, Cs and x is 2, or Mg, Ca, Sr or Ba and x is 1, and wherein Fe+30Cr+35Ni<about 60 ppm.

The first glass sheet can further comprise from about 0 mol % to about 10 mol % B₂O₃ in some embodiments. In additional embodiments, the first glass sheet can comprise less than about 1 ppm of each of Co, Ni, and Cr. The first glass sheet can, in various embodiments, produce less than or equal to about 2 dB/500 mm (such as less than or equal to 1 dB/500 mm or 0.5 dB/500 mm) of light attenuation and/or less than about 1 dB/500 mm (such as less than or equal to 0.5 dB/500 mm or less than or equal to 0.25 dB/500 mm) of light absorption in a wavelength range of about 400 nm to about 700 nm. In further embodiments, the first glass sheet can scatter light within an angle less than about 12.8 degrees full width half maximum (FWHM) in transmission mode and/or can diffuse light within an angle less than about 6.4 degrees in reflection mode. According to yet further embodiments, the first glass sheet can have a haze value of less than about 6%. In still further embodiments, the first glass sheet can comprise at least one surface having an RMS roughness (R_{q}) ranging from about 5 nm to about 75 nm. Exemplary glass sheets suitable for use as a light guide plate according to the present disclosure are described, for instance, in U.S. Patent Application No. 62/114,825 filed Feb. 11, 2015, U.S. Patent Application No. 62/026,264 filed Jul. 18, 2014, U.S. Patent Application No. 62/014,382 filed Jun. 19, 2014, U.S. Patent Application No. 62/132,258 filed Mar. 12, 2015 and International Patent Application No. PCT/US14/70771, each of which are incorporated herein by reference in their entireties.

For example, the first glass sheet can comprise from about 50 mol % to about 90 mol % SiO₂, from about 0 mol % to about 15 mol % Al₂O₃, and about 0 mol % to about 19 mol % RₓO, wherein x is 1 and R is chosen from Zn, Mg, Ca, Sr, or Ba, or wherein x is 2 and R is chosen from Li, Na, K, Rb, or Cs, and wherein RₓO—Al₂O3>0, such as 0<RₓO—Al₂O3<15. In some embodiments, when x=2, R₂O—Al₂O3<15, such as R₂O—Al₂O3<2. According to additional embodiments, when x=2, R₂O—Al₂O₃—MgO>−10. In further embodiments, 0<(RₓO—Al₂O₃)<12, −1<(R₂O—Al₂O₃)<11, and −10<(R₂O—Al₂O₃—MgO)<11. According to yet further embodiments, −1<(R₂O—Al₂O₃)<2 and −6<(R₂O—Al₂O₃—MgO)<1. In still further embodiments, at least about 10% of Fe in the first glass sheet can comprise Fe²⁺. The concentration of Fe in the first glass sheet can be less than about 50 ppm, such as less than about 20 ppm, or less than about 10 ppm, including all ranges and subranges therebetween. Moreover, Fe, Cr, and Ni can be present in the first glass sheet in concentrations such that Fe+30Cr+35Ni<about 60 ppm, such as less than about 40 ppm, less than about 20 ppm, or less than about 10 ppm, including all ranges and subranges therebetween.

The first glass sheet can comprise at least one edge that can scatter light within an angle less than about 12.8 degrees full width half maximum (FWHM) in transmission or reflection mode. A diffusion angle of at least one edge of the first glass sheet can be below about 6.4 degrees in reflection mode. The first glass sheet can further more comprise a density between about 1.95 g/cc to about 2.7 g/cc at 20° C. and/or a Young's modulus ranging from about 62 GPa to about 90 GPa and/or a coefficient of thermal expansion (CTE) ranging from about 30×10-7/° C. to about 95×10-7/° C. in a temperature range of 0-300° C.

In yet further embodiments, the first glass sheet can comprise at least one textured surface having an RMS roughness (R_{q}) ranging from about 5 nm to about 75 nm, such as from about 10 nm to about 50 nm, from about 15 n to about 40 nm, or from about 20 nm to about 30 nm, including all ranges and subranges therebetween. The haze value of the first glass sheet can be less than about 6% in some embodiments, such as less than about 5%, less than about 4%, less than about 3%, less than about 2%, less than about 1%, less than about 0.5%, less than about 0.25%, or less than about 0.1%, including all ranges and subranges therebetween. According to some embodiments, a transmittance of the glass sheet normal to at least one of its surfaces can be greater than about 85% over a wavelength range of 400-700 nm, such as greater than about 90%, or greater than about 95% transmittance. At least one surface of the first glass sheet can include one or more light extraction or scattering features, which can be produced, e.g., by printing or etching.

The second glass sheet 225 can comprise any glass suitable for use in automotive glazings, including the glass compositions described above with respect to the first glass sheet 205. Other suitable glass sheets may comprise, for example, soda lime, aluminosilicate, alkali-aluminosilicate, borosilicate, alkali-borosilicate, aluminoborosilicate, and alkali-aluminoborosilicate glasses, or other suitable glass materials. Non-limiting examples of commercially available glasses include, for example, Gorilla® Willow®, Lotus™, Iris™, and EAGLE XG® glasses from Corning Incorporated. Such glass sheets may be provided, for example, in accordance with U.S. Pat. Nos. 7,666,511, 4,483,700, and/or 5,674,790, which are incorporated herein by reference in their entireties. In some embodiments, the second glass sheet can comprise photochromic glass.

The first and/or second glass sheet 205, 225 can, in some embodiments, be treated, for example, chemically strengthened (e.g., ion-exchanged) and/or thermally tempered and/or annealed, to increase the strength of the glass and/or its resistance to breakage and/or scratching. According to some embodiments, the glass sheets can have a compressive stress greater than about 100 MPa and a depth of layer of compressive stress (DOL) greater than about 10 microns, for example, a compressive stress greater than about 500 MPa and a DOL greater than about 20 microns, or a compressive stress greater than about 700 MPa and a DOL greater than about 40 microns. For instance, a chemical strengthening process can impart a relatively high compressive stress (e.g., from about 700 MPa to about 730 MPa, or even greater than about 800 MPa) at a relatively high DOL (e.g., about 40 microns, or even greater than about 100 microns).

The first and second glass sheets can have a coefficient of thermal expansion (CTE) ranging, for example, from about 0.5×10⁻⁶/° C. to about 15×10⁻⁶/° C., such as from about 1×10⁻⁶/° C. to about 14×10⁻⁶/° C., from about 2×10⁻⁶/° C. to about 13×10⁻⁶/° C., from about 3×10⁻⁶/° C. to about 12×10⁻⁶/° C., from about 4×10⁻⁶/° C. to about 11×10⁻⁶/° C., from about 5×10⁻⁶/° C. to about 10×10⁻⁶/° C., from about 6×10⁻⁶/° C. to about 9×10⁻⁶/° C., or from about 7×10⁻⁶/° C. to about 8×10⁻⁶/° C., including all ranges and subranges therebetween. In certain embodiments, the glass sheets can have a CTE ranging from about 8×10⁻⁶/° C. to about 10×10⁻⁶/° C., for instance, ranging from about 8.5×10⁻⁶/° C. to about 9.5×10⁻⁶/° C. In other embodiments, the glass sheets can have a CTE ranging from about 3×10⁻⁶/° C. to about 5×10⁻⁶/° C., such as from about 3.5×10⁻⁶/° C. to about 4.5×10⁻⁶/° C. According to non-limiting embodiments, the CTE of the first glass sheet can be substantially similar to the CTE of the second glass sheet, such as within about 30% of the second CTE, within about 20%, within about 10%, or within about 5%, or less, including all ranges and subranges therebetween. It is to be understood that all CTE values disclosed herein are expressed as CTE measured over a temperature ranging from about 0° C. to about 300° C.

The first and second glass sheets, as well as the laminate structure or automotive glazing can, in various embodiments, be transparent or substantially transparent. As used herein, the term “transparent” is intended to denote that the glass sheet or glazing has a transmission of greater than about 85% in the visible region of the spectrum (400-700 nm). For instance, an exemplary transparent glass light guide or glazing may have greater than about 85% transmittance in the visible light range, such as greater than about 90%, greater than about 95%, or greater than about 99% transmittance, including all ranges and subranges therebetween. According to various embodiments, the glass light guide or glazing may have a transmittance of less than about 50% in the visible region, such as less than about 45%, less than about 40%, less than about 35%, less than about 30%, less than about 25%, or less than about 20%, including all ranges and subranges therebetween. In certain embodiments, an exemplary glass light guide or glazing may have a transmittance of greater than about 50% in the ultraviolet (UV) region (100-400 nm), such as greater than about 55%, greater than about 60%, greater than about 65%, greater than about 70%, greater than about 75%, greater than about 80%, greater than about 85%, greater than about 90%, greater than about 95%, or greater than about 99% transmittance, including all ranges and subranges therebetween. According to additional embodiments, the automotive glazing may not be transparent, e.g., opaque and/or colored, such as in the case of exterior or interior paneling.

In various embodiments, the laminate structure can have an overall thickness ranging from about 0.3 mm to about 12 mm, such as from about 0.5 mm to about 10 mm, from about 0.7 mm to about 9 mm, from about 1 mm to about 8 mm, from about 2 mm to about 7 mm, from about 3 mm to about 6 mm, or from about 4 mm to about 5 mm, including all ranges and subranges therebetween. Laminate structures and automotive glazings in accordance with the disclosure are not limited to structures comprising two glass sheets and/or a single interlayer. For example, the laminate structure can also include additional glass sheets and/or interlayers, or one or more optional layers. According to various embodiments, the use of additional layers can improve the acoustic performance of the glazing, e.g., the sound dampening or attenuation properties. In certain embodiments, the glazing can include a second interlayer attaching a third glass sheet to the laminate structure. According to further aspects of the disclosure, the laminate structures can comprise one or more additional substrates or layers, such as a polymer film, an additional glass layer, a reflective layer, a filtering layer, a polarizing layer, an electrochromic layer, an electrolytic layer, a sensor, indicator, or active device, and combinations thereof. For example, an electrochromic layer may include one or more electrically active thin films deposited on one or more surfaces of the substrates. Suitable electrochromic layers can include, but are not limited to, inorganic layers comprising tungsten trioxide WO₃. Of course, other combinations of layers and their respective features can be used to provide a wide array of configurations which are intended to fall within the scope of the disclosure.

The laminate structures and automotive glazings disclosed herein may offer one or more advantages over prior art laminates and glazings. For example, the automotive glazings can be sufficiently transparent to provide a clear view of the exterior surroundings of the vehicle, while still efficiently displaying a desired image. The displayed image can have an increased resolution and/or contrast ratio. The displayed image can be more readily visible in various lighting, such as in direct sunlight or in darkness. Moreover, the “ghosting” effect often observed with heads-up displays on transparent prior art glazings can be reduced or eliminated. The automotive glazing can also provide further functions and, such as defrosting and/or touchpad capabilities and/or interior ambient or directional lighting. Various vehicle components, such as side or rear view mirrors can be replaced by including automotive glazings disclosed herein in the vehicle, thereby possibly reducing the overall weight and increasing the fuel efficiency of the vehicle. Of course, it is to be understood that the glazings disclosed herein may not have one or more of the above advantages, but are intended to fall within the scope of the appended claims.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a glass sheet” includes examples having two or more such glass sheets unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a structure that comprises A+B+C include embodiments where a structure consists of A+B+C and embodiments where a structure consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1-35. (canceled)

36. A laminate structure comprising:
a first glass sheet;
an intermediate polymer interlayer; and
a second glass sheet,
wherein the first glass sheet is a light guide plate having from about 50 mol % to about 90 mol % SiO₂, from about 0 mol % to about 15 mol % Al₂O₃, and about 0 mol % to about 19 mol % RₓO,
wherein x is 1 and R is chosen from Zn, Mg, Ca, Sr, or Ba, or
wherein x is 2 and R is chosen from Li, Na, K, Rb, or Cs, and
wherein the concentration of Fe is less than about 50 ppm.

37. The laminate structure of claim 36, wherein the intermediate polymer interlayer is chosen from polyvinyl butyral, ethylene-vinyl acetate, thermoplastic polyurethanes, ionomers, and combinations thereof.

38. The laminate structure of claim 36, wherein the second glass sheet comprises a photochromic glass sheet.

39. The laminate structure of claim 36, wherein the second glass sheet is chosen from soda lime, aluminosilicate, alkali-aluminosilicate, borosilicate, alkali-borosilicate, aluminoborosilicate, and alkali-aluminoborosilicate glasses.

40. The laminate structure of claim 36, wherein at least one of the first or second glass sheets is chemically strengthened, thermally tempered, and/or annealed.

41. The laminate structure of claim 36, wherein the first or second glass sheet has a thickness ranging from about 0.3 mm to about 8 mm.

42. The laminate structure of claim 36, wherein the laminate structure is an automotive glazing comprising all or a portion of a windshield, rear window, side window, sunroof, moonroof, exterior panel, or interior panel of a vehicle.

43. The laminate structure of claim 36, further comprising at least one light source optically coupled to an edge of the light guide plate.

44. The laminate structure of claim 43, wherein the at least one light source is chosen from LEDs, CCFLs, OLEDs, and combinations thereof.

45. The laminate structure of claim 36, further comprising at least one additional component chosen from electrochromic layers, polymer layers, reflective layers, polarizing layers, filtering layers, sensors, indicators, active devices, and combinations thereof.

46. A laminate structure comprising
a first outer clad glass sheet; and
an interior core glass sheet;
wherein the interior core glass sheet is a light guide plate having from about 50 mol % to about 90 mol % SiO₂, from about 0 mol % to about 15 mol % Al₂O₃, and about 0 mol % to about 19 mol % RₓO,
wherein x is 1 and R is chosen from Zn, Mg, Ca, Sr, or Ba, or
wherein x is 2 and R is chosen from Li, Na, K, Rb, or Cs, and
wherein the concentration of Fe is less than about 50 ppm.

47. The laminate structure of claim 46, further comprising a second outer clad glass sheet, wherein the interior core glass sheet is intermediate the first and second outer clad glass sheets.

48. The laminate structure of claim 46, wherein the first or second outer clad glass sheet comprises a photochromic glass sheet.

49. The laminate structure of claim 46, wherein the first or second outer clad glass sheet is chosen from soda lime, aluminosilicate, alkali-aluminosilicate, borosilicate, alkali-borosilicate, aluminoborosilicate, and alkali-aluminoborosilicate glasses.

50. The laminate structure of claim 46, wherein at least one of the first or second outer clad glass sheet or interior core glass sheet is chemically strengthened, thermally tempered, and/or annealed.

51. The laminate structure of claim 46, wherein the first or second outer clad glass sheet or interior core glass sheet has a thickness ranging from about 0.3 mm to about 8 mm.

52. The laminate structure of claim 46, wherein the laminate structure is an automotive glazing comprising all or a portion of a windshield, rear window, side window, sunroof, moonroof, exterior panel, or interior panel of a vehicle.

53. The laminate structure of claim 46, further comprising at least one light source optically coupled to an edge of the light guide plate.

54. The laminate structure of claim 53, wherein the at least one light source is chosen from LEDs, CCFLs, OLEDs, and combinations thereof.

55. The laminate structure of claim 46, further comprising at least one additional component chosen from electrochromic layers, polymer layers, reflective layers, polarizing layers, filtering layers, sensors, indicators, active devices, and combinations thereof.
